(19) United States
(12) Patent Application Publication
(10) Pub. No.: US 2010/0283396 A1
(43) Pub. Date: Nov. 11, 2010

(54) LIGHT SOURCE SYSTEM AND LIGHT SOURCE DRIVING CIRCUIT

(76) Inventors: Chih-Chia Chen, Taipei City (TW); Yung-Chun Chuang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/719,844

(22) Filed: Mar. 8, 2010

(30) Foreign Application Priority Data
May 11, 2009 (TW) 098115545

(51) Int. Cl. H05B 37/02

(52) U.S. Cl. 315/185 R; 315/297

(57) ABSTRACT

A light source driving circuit includes a plurality of light-emitting loads, an operational amplifier, a plurality of transistors, an isolation circuit, and a reference circuit. The first ends of each transistor are electrically connected to the plurality of light-emitting loads respectively. The second end of each transistor is electrically connected to a current mirror. The control end of each transistor is electrically connected to the output end of the operational amplifier. The isolation circuit is electrically connected between the negative input end of the operational amplifier and the plurality of transistors.

### BACKGROUND OF THE INVENTION

1. Field of the Invention

The present invention is related to a light source system with circuit for balancing brightness.

2. Description of the Prior Art

FIG. 1 illustrates a conventional light source system 100. The light source system 100 comprises N light-emitting loads LL₁-LL_{N}, N operational amplifiers OP₁-OP_{N}, N bias transistor MA₁-MA_{N}, and a current mirror 105. The current mirror 105 comprises a current source 101, a reference transistor MB_{R}, and N mirror transistors MB₁-MB_{N}. The mirror transistors MB₁-MB_{N} duplicate current of the current source 101 to drive the light-emitting loads LL₁-LL_{N}.

Each mirror transistor MB₁-MB_{N} operates in the saturation region. The operational amplifiers OP₁-OP_{N} and the bias transistors MA₁-MA_{N} keep the voltage levels of the drain voltages of the mirror transistors MB₁-MB_{N} equal to a reference voltage V_{REF}, so that the currents provided by the transistors MB₁-MB_{N} to the light-emitting loads LL₁-LL_{N} are all equal, and each light-emitting load can output the same brightness.

In the prior art, one operational amplifier and one bias transistor are required for each light-emitting load to achieve consistent brightness levels. For N light-emitting loads, N operational amplifiers are required, dramatically increasing cost, area, and power consumption of the light source system.

### SUMMARY OF THE INVENTION

In one embodiment, a driving circuit for driving a plurality of light sources comprises an operational amplifier, a first transistor, a second transistor, a first capacitor, and a second capacitor. The operational amplifier has a positive input end for receiving a reference voltage, a negative input end, and an output end. The first transistor has a first end electrically connected to a first light-emitting load, a second end electrically connected to a current mirror, and a control end electrically connected to the output end of the operational amplifier. The second transistor has a first end electrically connected to a second light-emitting load, a second end electrically connected to the current mirror, and a control end electrically connected to the output end of the operational amplifier. The first capacitor is electrically connected between the negative input end of the operational amplifier and the second end of the first transistor. The second capacitor is electrically connected between the negative input end of the operational amplifier and the second end of the second transistor.

In another embodiment, a driving circuit for driving a plurality of light sources comprises an operational amplifier, a first transistor, a second transistor, a third transistor, a fourth transistor, a fifth transistor, a first current source, and a second current source. The operational amplifier has a positive input end, a negative input end, and an output end. The first transistor has a first end electrically connected to a first light-emitting load, a second end electrically connected to a current mirror, and a control end electrically connected to the output end of the operational amplifier. The second transistor has a first end electrically connected to a second light-emitting load, a second end electrically connected to the current mirror, and a control end electrically connected to the output end of the operational amplifier. The third transistor has a first end electrically connected to the negative input end of the operational amplifier, a second end electrically connected to a ground, and a control end electrically connected to the second end of the first transistor. The fourth transistor has a first end electrically connected to the negative input end of the operational amplifier, a second end electrically connected to the ground, and a control end electrically connected to the second end of the second transistor. The fifth transistor has a first end electrically connected to the positive input end of the operational amplifier, a second end electrically connected to the ground, and a control end for receiving a reference voltage. The first current source is electrically connected to the positive input end of the operational amplifier. The second current source is electrically connected to the negative input end of the operational amplifier.

A light source system according to one embodiment comprises a plurality of light-emitting loads, an operational amplifier, a plurality of transistors, an isolation circuit, and a reference circuit. The operational amplifier has a positive input end for receiving a reference voltage, a negative input end, and an output end. Each transistor of the plurality of the transistors has a first end respectively electrically connected to the plurality of light-emitting loads, a second end electrically connected to a current mirror, and a control end electrically connected to the output end of the operational amplifier. The isolation circuit is electrically connected between the negative input end of the operational amplifier and the plurality of the transistors. The reference circuit is electrically connected to the positive input end of the operational amplifier.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a conventional light source system.

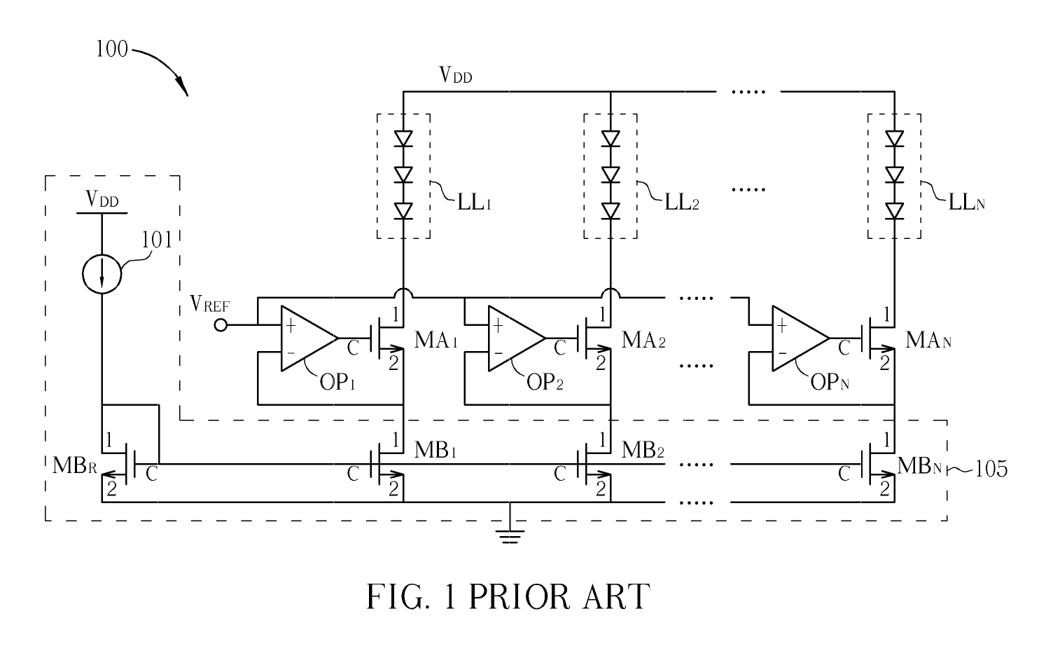

FIG. 2 shows a light source system according to a first embodiment.

FIG. 3 shows a light source system according to an embodiment.

FIG. 4 shows a light source system according to a second embodiment.

### DETAILED DESCRIPTION

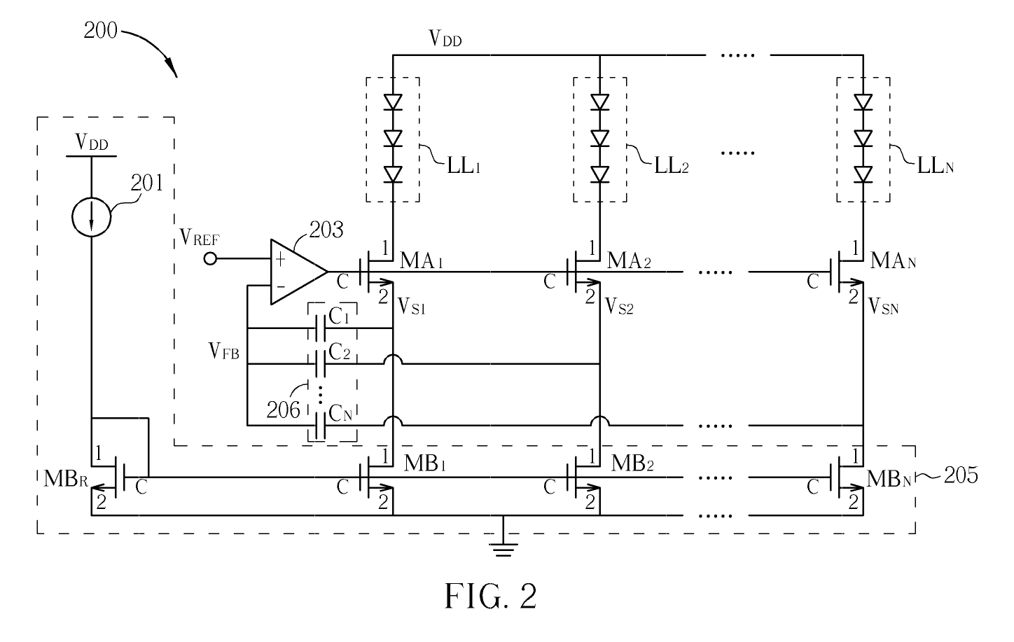

FIG. 2 is a circuit diagram of a light source system 200. The light source system 200 may comprise N light-emitting loads LL₁-LL_{N}, an operational amplifier 203, N bias transistors MA₁-MA_{N}, an isolation circuit 206, and a current mirror 205. Each light-emitting load LL₁-LL_{N} may comprise a plurality of light-emitting diodes connected in series. The isolation circuit 206 may comprise N capacitors C₁-C_{N} for isolating currents of the light-emitting loads LL₁-LL_{N}. The current mirror 205 may comprise a current source 201, a reference transistor MB_{R}, and N mirror transistors MB₁-MB_{N}. The drain of the reference transistor MB_{R} is electrically connected to the current source 201; the gate of the reference transistor MB_{R} is electrically connected to the drain of the reference transistor MB_{R}; the source of the reference transistor MB_{R} is electrically connected to ground; and the gates of the mirror transistors MB₁-MB_{N} are electrically connected to the gate of the reference transistor MB_{R}. Therefore, the mirror transistors MB₁-MB_{N} may duplicate the current provided by the current source 201. The sources of the bias transistors MA₁-MA_{N} is electrically connected to the drains of the mirror transistors MB₁-MB_{N}, respectively; the drains of the bias transistors MA₁-MA_{N} is electrically connected to the light-emitting loads LL₁-LL_{N}, respectively; and the gates of the bias transistors MA₁-MA_{N} are electrically connected to the output end of the operational amplifier 203. The capacitors C₁-C_{N} are respectively electrically connected between the sources of the bias transistors MA₁-MA_{N} and the negative input end of the operational amplifier 203. The positive input end of the operational amplifier 203 receives a reference voltage V_{REF}. In addition, the capacitances of the capacitors C₁-C_{N} may all be equal.

In the first embodiment of the present invention, the operational amplifier 203 may respectively control the source voltages of the bias transistors MA₁-MA_{N} (the drain voltages of the mirror transistors MB₁-MB_{N}) through the capacitors C₁-C_{N}, so that the currents generated by the transistors MB₁-MB_{N} may all be equal, for balancing the output brightness of the light-emitting loads LL₁-LL_{N}. As mentioned above, since the capacitors C₁-C_{N} may be electrically connected between the sources of the bias transistors MA₁-MA_{N} and the negative input end of the operational amplifier 203, the source voltages V_{S1}-V_{SN} of the bias transistors MA₁-MA_{N} are fed back to the negative input end of the operational amplifier 203 through the corresponding capacitors C₁-C_{N}. Because of the capacitor effect, the feedback voltage V_{FB} received by the negative input end of the operational amplifier 203 may be represented as:

$${V}_{FB} = \frac{{\sum }_{K = 1}^{N} {C}_{K} \times {V}_{SK}}{{\sum }_{K = 1}^{N} {C}_{K}} ; \qquad ( 1 )$$

Since the two input ends of the operational amplifier 203 form a virtual short circuit, the output end of the operational amplifier outputs a gate control voltage V_{G} to each bias transistor MA₁-MA_{N} for controlling drain current amplitude of each bias transistor MA₁-MA_{N}, so as to keep the voltage level of the feedback voltage V_{FB} equal to the reference voltage V_{REF}. For instance, when the source voltage V_{S1} of the bias transistor MA₁ decreases by ΔV, the feedback voltage V_{FB} may decrease by ΔV/N (the capacitors C₁-C_{N} are connected in parallel, and capacitances of the capacitors C₁-C_{N} are all equal). Hence, the gate control voltage V_{G} outputted by the operational amplifier 203 is lowered. The source voltages VS₁-VS_{N} rise to compensate for the voltage drop ΔV of the source voltage V_{S1}, thereby balancing the current of each light-emitting load LL₁-LL_{N}.

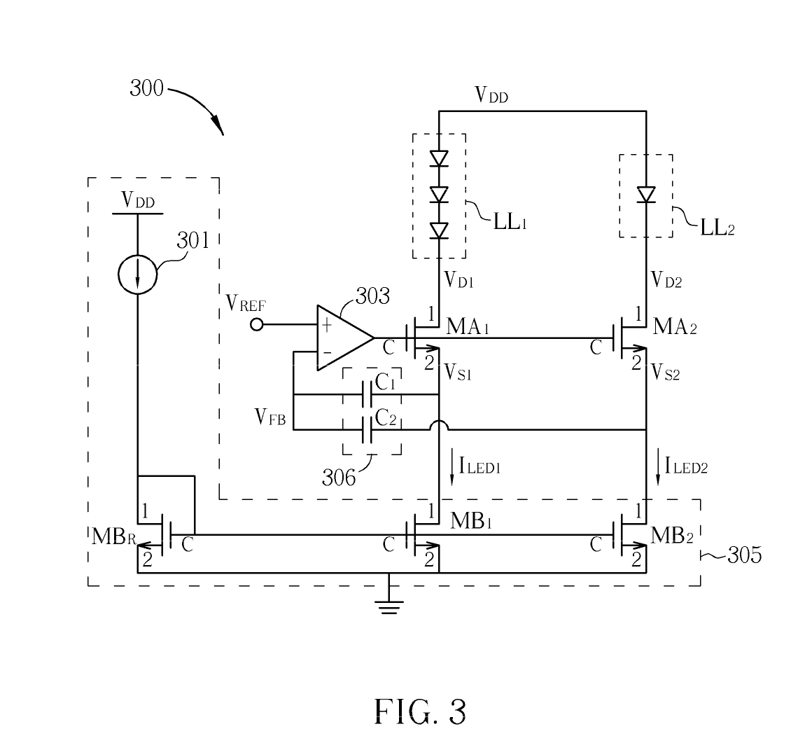

FIG. 3 is a circuit diagram of a light source system 300. In the present embodiment, the number of the light-emitting loads is set to two as an example. It is assumed that the capacitances of the capacitors C₁ and C₂ of the isolation circuit 306 are equal. When the source voltage V_{S1} decreases by ΔV, the feedback voltage V_{FB} decreases by ΔV/2 according to the formula (I). As a result, the gate control voltage V_{G} outputted by the operational amplifier 303 may be lowered. The source voltages V_{S1} and VS₂ may increase to compensate for the voltage drop ΔV of the gate voltage V_{S1}. In this way, the difference between the magnitudes of the currents I_{LED1}, I_{LED2} passing through the light-emitting loads LL₁, LL₂ may be reduced by the operational amplifier 303 and the bias transistors MA₁, MA₂. Thus, the output brightness of the light-emitting loads may be balanced.

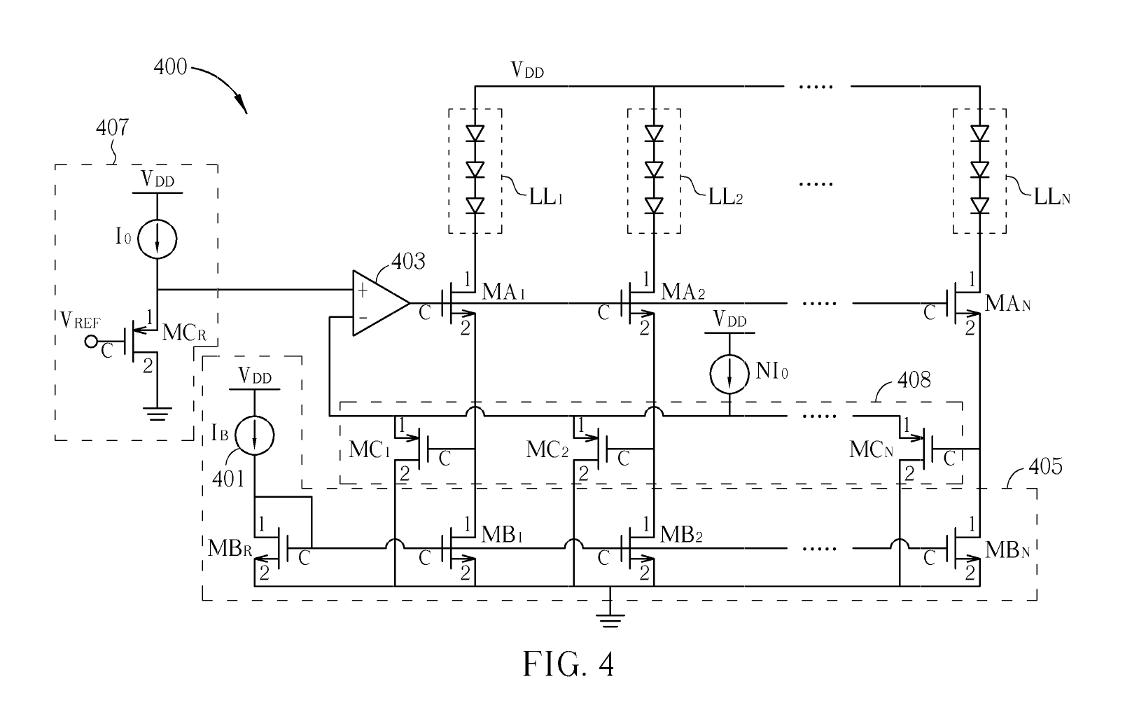

FIG. 4 illustrates a light source system 400 according to a second embodiment. The light source system 400 may comprise N light-emitting loads LL₁-LL_{N}, an operational amplifier 403, N bias transistors MA₁-MA_{N}, an isolation circuit 408, a current mirror 405, and a reference circuit 407. Each light-emitting load LL₁-LL_{N} may comprise a plurality of light-emitting diodes connected in series. The isolation circuit 408 may comprise N control transistors MC₁-MC_{N} for isolating the currents of the light-emitting loads LL₁-LL_{N}. The current mirror 405 may comprise a current source 401, a reference transistor MB_{R}, and N mirror transistors MB₁-MB_{N}. The drain of the reference transistor MB_{R} is electrically connected to the current source 401; the gate of the reference transistor MB_{R} is electrically connected to the drain of the reference transistor MB_{R}; and the source of the transistor MB_{R} is electrically connected to ground. The gates of the mirror transistors MB₁-MB_{N} are electrically connected to the gate of the reference transistor MB_{R}, so that the mirror transistors MB₁-MB_{N} duplicate the current of the current source 401. The sources of the bias transistors MA₁-MA_{N} are electrically connected to the drains of the mirror transistors MB₁-MB_{N}, respectively. The drains of the bias transistors MA₁-MA_{N} are electrically connected to the light-emitting loads LL₁-LL_{N}, respectively. The gates of the bias transistors MA₁-MA_{N} are electrically connected to the output end of the operational amplifier 403.

In the second embodiment, the operational amplifier 403 controls the source voltages of the bias transistors MA₁-MA_{N} (the drain voltages of the mirror transistors MB₁-MB_{N}) through the control transistors MC₁-MC_{N}, so that the magnitudes of the currents generated by the mirror transistors MB₁-MB_{N} may all be equal, balancing the output brightness of the light-emitting loads LL₁-LL_{N}. The sources of the control transistors MC₁-MC_{N} are electrically connected to the negative input end of the operational amplifier 403; the drains of the control transistors MC₁-MC_{N} are electrically connected to ground; and the gates of the control transistors MC₁-MC_{N} are electrically connected to the sources of the bias transistors MA₁-MA_{N}, respectively. The reference circuit 407 comprises a current source I₀ and a transistor MC_{R}. The gate of the transistor MC_{R} is utilized for receiving a reference voltage V_{REF}; the source of the transistor MC_{R} is electrically connected to the current source I₀; and the drain of the transistor MC_{R} is electrically connected to the ground. The current source NI₀ may provide current having magnitude N times the magnitude of the current of the current source I₀, to the sources of the transistors MC₁-MC_{N}. The positive input end of the operational amplifier 403 is electrically connected to the source of the transistor MC_{R}, and the negative input end of the operational amplifier 403 is electrically connected to the sources of the control transistors MC₁-MC_{N}. Since the two input ends of the operational amplifier 403 form a virtual short circuit, the gate voltages of the transistors MC₁-MC_{N} may all be equal to the reference voltage V_{REF}. When the gate voltage of the transistor MC₁ decreases by ΔV, the current passing through the control transistor MC₁ may increase, decreasing the currents passing through the control transistors MC₁-MC_{N}. Thus, the feedback voltage V_{FB} on the negative input end of the operational amplifier 403 may decrease by ΔV/N. The operational amplifier 403 may control the gate voltages of the bias transistors MA₁-MA_{N} according to the voltage drop ΔV/N to adjust the currents passing through the light-emitting loads LL₁-LL_{N}. The operation of the operational amplifier 403 is similar to that in the first embodiment, and is not repeated for brevity.

The light source system in the above embodiments requires only one operational amplifier to balance the currents passing through the light-emitting loads in the light source system. The source voltages of the bias transistors corresponding to the light-emitting loads may be fed back to the operational amplifier through the isolation circuit, so that the operational amplifier may control the source voltages of the bias transistors to be equal, keeping the currents provided by the transistors of the current mirror to the light-emitting loads equal.

Those skilled in the art will readily observe that numerous modifications and alterations of the device and method may be made while retaining the teachings of the invention.

What is claimed is:

1. A light source driving circuit, comprising:
an operational amplifier, having a positive input end for receiving a reference voltage, a negative input end, and an output end;
a first transistor, having a first end electrically connected to a first light-emitting load, a second end electrically connected to a current mirror, and a control end electrically connected to the output end of the operational amplifier;
a second transistor, having a first end electrically connected to a second light-emitting load, a second end electrically connected to the current mirror, and a control end electrically connected to the output end of the operational amplifier;
a first capacitor, electrically connected between the negative input end of the operational amplifier and the second end of the first transistor; and
a second capacitor, electrically connected between the negative input end of the operational amplifier and the second end of the second transistor.

2. The light source driving circuit of claim 1, wherein the first light-emitting load comprises a plurality of light-emitting diodes connected in series, and the second light-emitting load comprises a plurality of light-emitting diodes connected in series.

3. The light source driving circuit of claim 1, wherein the current mirror comprises:
a current source;
a third transistor, having a first end electrically connected to the current source, a second end electrically connected to a ground, and a control end electrically connected to the first end of the third transistor;
a fourth transistor, having a first end electrically connected to the second end of the first transistor, a second end electrically connected to the ground, and a control end electrically connected to the control end of the third transistor; and
a fifth transistor, having a first end electrically connected to the second end of the second transistor, a second end electrically connected to the ground, and a control end electrically connected to the control end of the third transistor.

4. A light source driving circuit, comprising:
an operational amplifier, having a positive input end, a negative input end, and an output end;
a first transistor, having a first end electrically connected to a first light-emitting load, a second end electrically connected to a current mirror, and a control end electrically connected to the output end of the operational amplifier;
a second transistor, having a first end electrically connected to a second light-emitting load, a second end electrically connected to the current mirror, and a control end electrically connected to the output end of the operational amplifier;
a third transistor, having a first end electrically connected to the negative input end of the operational amplifier, a second end electrically connected to a ground, and a control end electrically connected to the second end of the first transistor;
a fourth transistor, having a first end electrically connected to the negative input end of the operational amplifier, a second end electrically connected to the ground, and a control end electrically connected to the second end of the second transistor;
a fifth transistor, having a first end electrically connected to the positive input end of the operational amplifier, a second end electrically connected to the ground, and a control end for receiving a reference voltage;
a first current source, electrically connected to the positive input end of the operational amplifier; and
a second current source, electrically connected to the negative input end of the operational amplifier.

5. The light source driving circuit of claim 4, wherein the first light-emitting load comprises a plurality of light-emitting diodes connected in series, and the second light-emitting load comprises a plurality of light-emitting diodes connected in series.

6. The light source driving circuit of claim 4, wherein the current mirror comprises:
a third current source;
a sixth transistor, having a first end electrically connected to the current source, a second end electrically connected to the ground, and a control end electrically connected to the first end of the sixth transistor;
a seventh transistor, having a first end electrically connected to the second end of the first transistor, a second end electrically connected to the ground, and a control end electrically connected to the control end of the sixth transistor; and
an eighth transistor, having a first end electrically connected to the second end of the second transistor, a second end electrically connected to the ground, and a control end electrically connected to the control end of the sixth transistor.

7. The light source driving circuit of claim 4, wherein the current provided by the second current source is larger than the current provided by the first current source.

8. A light source system, comprising:
a plurality of light-emitting loads;
an operational amplifier, having a positive input end for receiving a reference voltage, a negative input end, and an output end;
a plurality of transistors, each transistor of the plurality of the transistors having a first end electrically connected to a corresponding light-emitting load of the plurality of light-emitting loads, a second end electrically connected to a current mirror, and a control end electrically connected to the output end of the operational amplifier;
an isolation circuit, electrically connected between the negative input end of the operational amplifier and the plurality of the transistors, for isolating currents of the plurality of the light-emitting loads; and
a reference circuit, electrically connected to the positive input end of the operational amplifier.

9. The light source system of claim 8, wherein each of the plurality of the light-emitting loads comprises a plurality of light-emitting diodes connected in series.

10. The light source system of claim 8, wherein the isolation circuit comprises:
a plurality of capacitors, each capacitor electrically connected between the negative input end of the operational amplifier and the second end of a corresponding transistor of the plurality of the transistors.

11. The light source system of claim 10, wherein the reference circuit is a reference voltage source.

12. The light source system of claim 8, wherein the isolation circuit comprises:
a plurality of transistors, each transistor having a first end electrically connected to the negative input end of the operational amplifier, a second end electrically connected to a ground, and a control end electrically connected to the second end of a corresponding transistor of the plurality of the transistors.

13. The driving circuit of light source of claim 8, wherein the reference circuit comprises:
a transistor, having a first end electrically connected to the positive input end of the operational amplifier, a second end electrically connected to the ground, and a control end for receiving a reference voltage; and
a current source, electrically connected to the first end of the transistor of the reference circuit.
